(19) United States
(12) Patent Application Publication
(10) Pub. No.: US 2007/0121146 A1
(43) Pub. Date: May 31, 2007

(54) Image processing system

(76) Inventors: Steve Nesbit, York (GB); Tony Klinger, Waltham Abbey (GB); Eve Hawking, Werrington (GB)

Correspondence Address: PYLE & PIONTEK, ROOM 2036, 221 N LASALLE, CHICAGO, IL, 60601, US

(21) Appl. No.: 11/287,596

(22) Filed: Nov. 28, 2005

(51) Int. Cl. G06F 3/12

(52) U.S. Cl. 358/1.15

(57) ABSTRACT

A method of providing media data to devices connected to a communications network is disclosed. The method comprises storing a plurality of media objects, each media object comprising image data. The media objects may be images or video clips. A request is received from a device connected to the network, the request comprising input image data and specifying one of the plurality of stored media objects. At least a portion of the input image data is composited with image data of the specified media object to produce a composite media object, and the composite media object is transmitted to the device. The method may be used with mobile telecommunications networks or over the Internet. An image processing system is also disclosed.

### BACKGROUND OF THE INVENTION

1. Field of the Invention

The present invention relates to an image processing system. Particular examples relate to systems and methods for providing media data to devices connected to a communications network.

2. Description of the Related Art

Modern telecommunications networks are capable of providing services which go beyond mere telephony. For example, text message (SMS) and multimedia message (MMS) services have become increasingly popular. Modern handsets often provide a wide range of multimedia functionality, with many devices now incorporating digital cameras.

However, to date, these multimedia capabilities have not been used to their full potential. To keep costs low, network operators and service providers have focused on simple services which can be provided efficiently and automatically, with services on many networks typically being limited to the simple messaging applications mentioned above. Existing service delivery architectures and processes may not be sufficiently flexible to enable the provision of more advanced multimedia services which can more fully exploit the capabilities of devices.

The present invention seeks to alleviate some of the above problems.

### BRIEF SUMMARY OF THE INVENTION

Accordingly, in a first aspect of the invention, there is provided a method of providing media data to devices connected to a communications network, comprising: storing a plurality of media objects, each media object comprising image data; receiving a request from a device connected to the network, the request comprising input image data and specifying one of the plurality of stored media objects; compositing at least a portion of the input image data with image data of the specified media object to produce a composite media object; and transmitting the composite media object to the device.

The stored media objects may be images, animations and/or video clips. The input image data and the resulting composite media object may similarly be images, animations or video clips. Thus, an input image may be composited with a stored image to produce a composite image or with a stored video clip (or animation) to produce a composite video clip (or animation). Alternatively, an input video clip (or animation) may be composited with a stored image or a stored video clip (or animation) to produce a composite video clip (or animation). The term ‘media object’ preferably refers to a unit of image data (optionally accompanied by other media data, e.g. sound), and encompasses individual static images as well as sequences of video images or video frames (such sequences are referred to here as video clips). Media objects may alternatively or additionally comprise animation data defining animations. The term ‘animation’ here encompasses any form of animation, including, for example, frame-based animation, vector animation or procedural animation. The term ‘video clip’ preferably encompasses any such animations. The term ‘image data’ preferably refers to image data of static images or of video/animation frames in video clips, or to image data associated with animations.

The compositing step preferably comprises selecting a portion of the input image data, extracting the selected portion from the input image data, and compositing the extracted portion with image data of the specified media object.

Preferably, the method comprises receiving the request at a media server; in response to receiving the request, selecting one of a plurality of media processors connected to the media server; and performing at least part of the compositing step at the selected media processor. This can allow image processing work to be distributed amongst multiple media processors, which can provided improved efficiency.

The term ‘media processor’ preferably refers to a processing unit or entity which provides media processing functionality (in particular image processing functionality). A media processor may be in the form of a processing device or multiple connected processing devices, such as one or more computers, and may include image processing software. The processing performed by a media processor may include manual image processing operations, and the media processor may thus include a human operator for performing those operations. In a typical example, a media processor includes a computer, image processing software running on the computer, and a human operator operating the image processing software to perform the required image processing operations (e.g. the compositing). A media processor may also be a business entity, such as a company, providing image processing services. The media processors are typically connected to the media server via a network, and are typically remote from the media server. The media server itself may include a single computer or multiple connected computers. The term ‘communications network’ preferably includes any network over which data can be transmitted, such as telecommunications networks and computer networks.

In a further aspect, the invention provides a media processing system for use with a communications network, comprising: a database adapted to store a plurality of media objects, each media object comprising image data; a media server connectable to the communications network, adapted to receive a request from a device connected to the communications network, the request comprising input image data and specifying one of the plurality of stored media objects; means for performing a compositing process to composite at least a portion of the input image data with image data of the specified media object to produce a composite media object; and means for transmitting the composite media object to the device.

In a further aspect, the invention provides a computer program or computer program product comprising software code adapted, when executed on a data processing apparatus, to perform a method of providing media data to devices connected to a communications network, comprising: storing a plurality of media objects, each media object comprising image data; receiving a request from a device connected to the network, the request comprising input image data and specifying one of the plurality of stored media objects; compositing at least a portion of the input image data with image data of the specified media object to produce a composite media object; and transmitting the composite media object to the device.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE SEVERAL VIEWS OF THE DRAWINGS

Preferred features of the present invention will now be described, purely by way of example, with reference to the accompanying drawings, in which:

FIG. 1 schematically illustrates a media processing system;

FIG. 2 illustrates the composition of an input image with a background image to produce an output image; and

FIG. 3 illustrates a method of processing image processing requests.

### DETAILED DESCRIPTION OF THE PREFERRED EMBODIMENTS

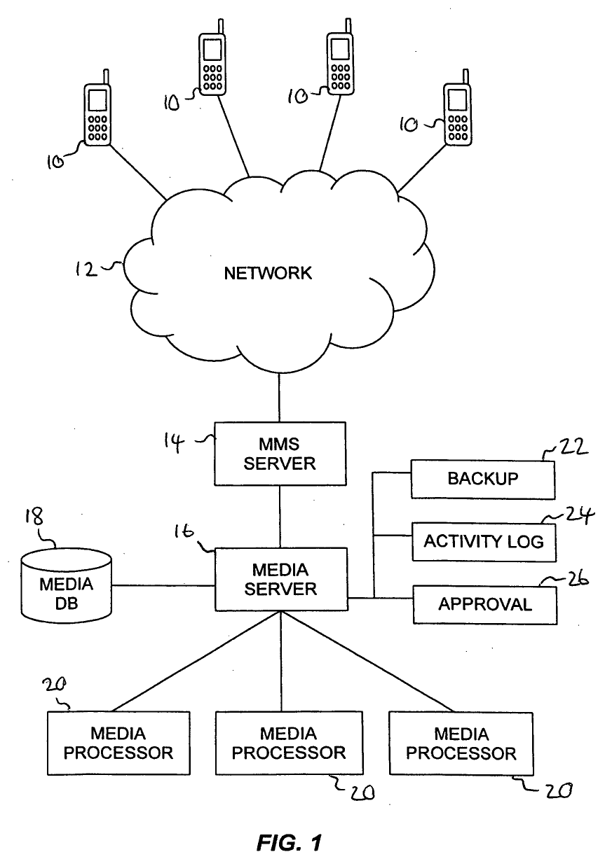

FIG. 1 illustrates a media processing system for compositing image data received from a mobile handset connected to a telecommunications network with image data from an image/video library, and outputting the composite image or video clip to the mobile handset. For clarity, a system will first be described in which input images are composited with background images, resulting in composite images; however, as will be described in more detail later, video clips can also be used, either as the input from the user or as the background or both, in which case the output of the system is typically a composite video clip.

The image library typically stores images of celebrities or other high-profile personalities. The user typically transmits an image of a person (possibly themselves) to the system. The system combines the image received from the user with the image of the celebrity to produce a pseudo-photographic image which appears to show the user in the company of the celebrity. Instead of or in addition to celebrity images, other types of images may be used, for example cartoons, film or sporting scenes, novelty images, greetings cards, flash animations or images of famous places.

As shown in FIG. 1, the system comprises a number of mobile devices 10, such as mobile telephone handsets, connected to a mobile telecommunications network 12. The mobile devices 10 include digital cameras and MMS functionality.

A media server 16 is connected to the network 12 via an MMS server 14. The media server 16 is further connected to a media database 18, and to one or more media processors 20. Also connected to the media server 16 are a backup module 22, an activity log module 24, and an image approval module 26.

In use, an image processing request is transmitted from a subscriber's mobile device 10 to the network 12 in the form of an MMS message. The MMS message includes an input image, typically obtained using the built-in digital camera, and a text portion with an image identifier specifying a desired background image for use in the compositing process.

The MMS message is received at MMS server 14, which extracts the image data and the background image identifier and stores these in a form suitable for processing by the media server 16. The request is then transmitted in this modified form to the media server 16 along with information identifying the originating subscriber.

The media server 16 receives the request from the MMS server and identifies the desired background image in the media database 18. Media server 16 then selects one of the available media processors 20 and transmits the received image data and the selected background image to the selected media processor for compositing. The selected media processor 20 composites the input image and the selected background image to produce a composite image and transmits the composite image back to the media server 16. The media server in turn transmits the composite image to the MMS processor 14, where the image is embedded in an MMS message and sent to the subscriber device 10 via network 12.

The media server may additionally carry out a number of other functions including storing a backup of the received input image and related job information using backup module 22, recording a log of processing actives using an activity log module 24, and outputting a composite image received from a media processor 20 to an image approval module 26 for review and quality control by an operator.

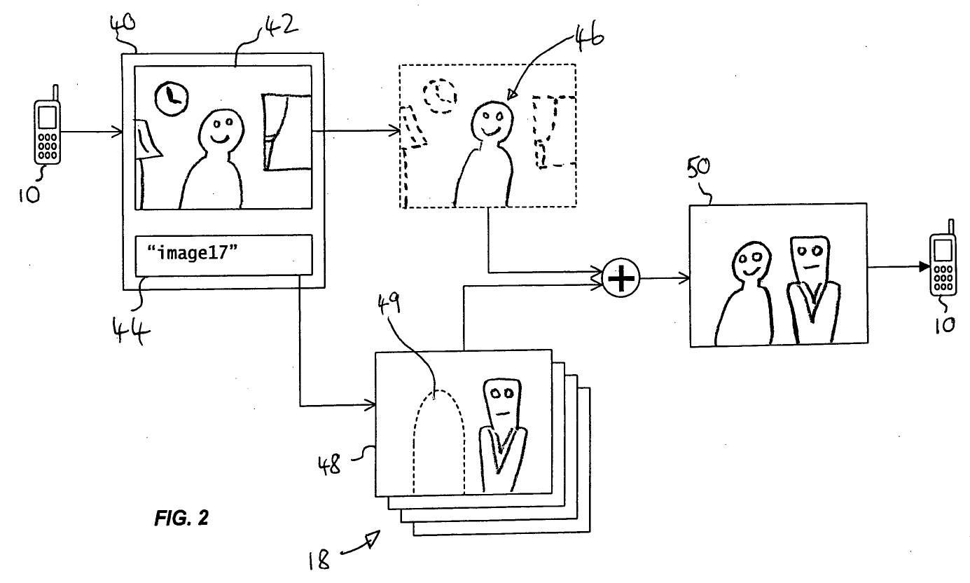

The compositing process is illustrated in more detail in FIG. 2. Mobile handset 10 generates an image processing request in the form of a multimedia message (MMS) 40, the message including an input image 42, typically obtained using a digital camera of the device 10, and a text portion 44 including a picture code which identifies an image 48 in the library of images stored in media database 18. The input image typically shows a person but includes other visual elements, referred to here as the image background. The media processor extracts the relevant portion 46 of the image 42, removing the background. The extracted image portion 46, typically the portion showing the person or the person's head, is then composited with the identified background image 48. The extracted portion 46 need not have a rectangular outline but may instead have an irregular outline which follows the outline of the image element of interest, typically the outline of the person.

The compositing processes may be carried out automatically or manually, for example using commercially available image processing software. The background 48 may have a predefined region 49 (indicated with the dotted line in the drawing) into which the relevant portion 46 of the input image is to be inserted. The defined region may be marked in the image 48 or may be specified separately. Alternatively, where compositing is performed manually, an operator may select the location of the background image into which to insert input image portion 46.

The relevant portion 46 of the input image 42 may be selected automatically with the help of edge detection and/or object detection algorithms, or may be manually selected using a selection tool in an interactive image processing application. The selected image portion 46 is then added to background image 48 at an appropriate position, for example as a layer in a layered image format. The compositing process may include further image manipulation steps, such as adjusting colour properties of the input image portion 46 (e.g. brightness or contrast) to more closely match the background image 48, and scaling the input image portion 46 to a suitable size. The resulting composite image 50 is output in a suitable image format (for example JPEG) and transmitted back to mobile device 10.

The elements of the system illustrated in FIG. 1 and the processing performed by those elements will now be described in more detail.

The Mobile Device

As mentioned above, the mobile device 10 is typically a mobile telephone handset including a digital camera and multimedia messaging functionality. The input image is typically obtained by way of the digital camera, but may also be obtained from a different source; for example, it may have been received in a message from another subscriber, or downloaded from the Internet.

The Network

In the present example, the network 12 is a mobile telephone network, though the system may also be used with other networks such as the Internet. In this example, the request is transmitted via the network 12 in the form of an MMS message. A telephone number or short code is assigned to the service, MMS messages being addressed to that number or code.

MMS Server

The MMS server 14 is responsible for the initial and final processing of each MMS message received from and sent to the user's handset.

Different types of handsets typically send MMS messages using slightly different formats. The MMS server 14 therefore processes the incoming message to place the data in a standard format. A job identifier is assigned to the request and the request data is made available to the media server 16.

Media Server

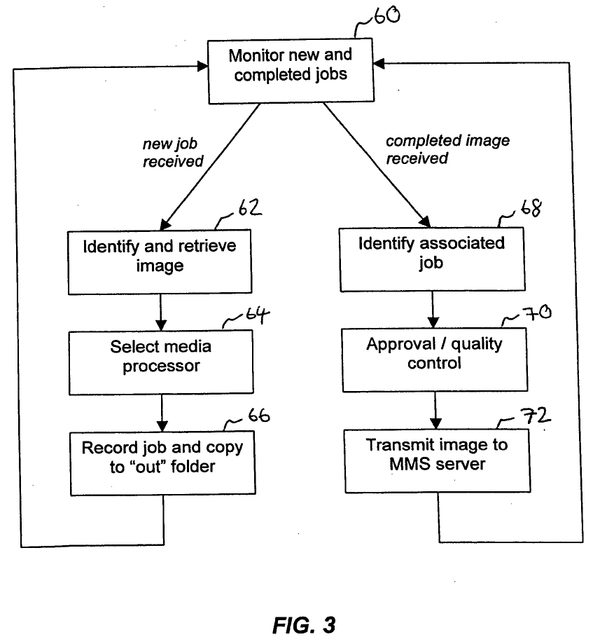

The media server 16 receives incoming jobs from the MMS server 14 and assigns the compositing work to media processors 20. The processing performed by the media server 16 is summarised in FIG. 3.

In step 60, the media server 16 monitors for new jobs received from MMS server 14 and for completed jobs received from media processors 20. Upon receiving a new job, the media server identifies the required background image in database 18 in step 62, and selects one of the available media processors 20 for carrying out the compositing work in step 64. The selection may be based on a number of criteria, for example the existing distribution of work, or the image format. In a preferred example, the database comprises information specifying which media processor is to be used for each background image, and the compositing work is then allocated accordingly. The media server records details of the job in the database, and transmits job information including the input image to the selected media processor 20 in step 66. The media server then returns to the monitoring step 60.

If a completed job is received from a media processor 20, the media server identifies the job in step 68 and transmits the composite image to the image approval module 26 in step 70. If the approval module signals that the composite image is of acceptable quality, then the composite image is transmitted to MMS server 14 at step 72 for onward transmission to the mobile subscriber. The media server then returns to the monitoring step 60.

A single monitoring process may be provided to perform the above steps. Alternatively, separate monitoring processes can be provided for the receipt of new jobs and the receipt of completed jobs respectively.

Media Processor

The media processor 20 may include automatic image processing software, human operators, or a combination of the two. By having the image adjustment and compositing steps performed by a human operator, higher quality results can sometimes be achieved. The media processor 20 receives the input and the background image, and performs the composition as described above with reference to FIG. 2. As an alternative or in addition to storing the image library of background images in a database 18 connected to a media server 16, the media processors may each maintain local copies of the background images (or of those images relevant to that media processor), with the information received from media server 16 merely identifying the relevant background image rather than including the image itself.

Media processors are typically external to, and remote from, the media server. The media server itself is typically operated by the provider of the image compositing service, and the media processors are operated by separate, specialist, service providers. Outsourcing of the image processing work (in particular the manual part of the image processing work) can reduce the cost of image processing and can allow the system to process a greater volume of work.

Media Database

The media database 18 stores the background images available for compositing and for each image specifies a picture code which uniquely identifies the image.

The database may also be used to store cost information relating to background images, correction rules for correcting misspellings in picture codes as described in more detail below, and job information (including job status information) regarding jobs being processed.

Additionally, the database may specify processing information relating to the image, for example specifying a location or region of the image into which the input image portion is to be inserted. This information may also be encoded in the image itself by way of one or more markers or outlines. Processing information may also be stored separately, and may, for example, take the form of a template, script or project file, defining processing operations to be performed during compositing, such as colour modification, resizing, cropping and three-dimensional projection operations. The template, script or project file associated with a background image can then be used to control an image processing application. This is described in more detail below.

Instead of providing the image compositing service described via a mobile telecommunications network, the service may alternatively or additionally be provided over the Internet. In this example, the input image and information selecting a background image may be transmitted by email. Alternatively, a web interface may be provided. In that case, the web interface allows the user to upload an input image, and displays a number of background images for selection by the user. After completion of the compositing process, the composite image is then transmitted to the user, for example by email to a specified email address.

Preferred embodiments combine both a web-based interface and a mobile telephone network interface to the service. Thus, in such cases, the media server 16 is able to receive requests either from the MMS server 14 (see FIG. 1) or from a web-based interface, and to return the composite image using an appropriate transmission method.

In the above example, static images are inserted into static background images, with the output being a static composite image. However, in preferred embodiments the system can also use video or animation data as either or both the input and/or the background.

In an example, the MMS message sent from the mobile subscriber device 10 includes a static input image, and a text portion identifying a video clip stored in media database 18. The static input image is then composited with the specified video clip. This typically involves compositing the input image with multiple frames of the video clip. In a similar fashion, a video clip could also be transmitted from the mobile device 10 to be composited with another video clip stored in media database 18.

As mentioned previously, the compositing process performed by media processors 20 may be manual, or may be partially or wholly automated. Automation may be particularly suitable where the input image is to be inserted wholly into the background image, for example into a designated area of the background image. In one example, a picture-in-video service is provided, in which a background video clip has a designated rectangular area in each frame. The input image is then scaled and optionally cropped to the correct size and inserted into the designated area in the frames of the video clip. Automation can be achieved by predefining a script or project file for an image or video processing application, for example a project file for the Adobe After Effects (™) application. The image or video processing application is then executed with the predefined project file and the relevant input image.

### Detailed Example

An example implementation of the image processing system will now be described in more detail.

As described above, to use the system, a user sends an MMS message (normally to a short code number) with their picture and a text code specifying the requested background image (for example ‘Joli001’) inside the message.

The MMS message then arrives at the MMS server 14 where it is checked and modified to place the data in a standard format. In this specific example, after checking, the image file (stored as a JPG) is renamed to ‘image.jpg’ and the contents of the text area are put inside a text file named ‘text.txt’.

After renaming, the package is then assigned a job number and compressed into a single ‘zip’ file, with the assigned job number used as the file name (e.g.: “6378815.zip”). This file is placed in a designated “New MMS” area of the MMS server 14 where it is made available for FTP download.

New jobs are downloaded to the media server 16 via FTP or http connection. For each job, the contents of the compressed file are extracted into a unique folder representing the job, and are checked and backed up. The media database 18 is checked to confirm if the background requested (as specified in the contents of the “text.txt” file) is valid and exists. If it does not, this is an error and the job is put aside into a separate area. If the picture code is valid and the specified background image exists, the image file is then renamed to the picture code specified in the “text.txt” file (eg: from “image.jpg” to “Joli001.jpg”). The other items of the package are not changed. The job is then assigned to one of the external media processors 20, and the job folder is moved to another area designated in the database for the selected media processor 20, ready for download by the media processor. Each job is assigned to a batch and stored in a corresponding batch folder.

For each background image, the database specifies the media processor to which the compositing work should be assigned under normal circumstances. However, this assignment may be overridden in certain circumstances, for example to balance workload between media processors.

The relevant media processor 20 logs onto the media server 16 via FTP and downloads each batch folder as required. After download, the media processor processes the batch folder, accessing each job folder to perform the required compositing work on the images. The media processor saves the resulting composite image (i.e. the output image) as new_filename.jpg (with the filename again being the picture code, eg: new_Joli001.jpg) back to the job folder of the relevant job. The use of consistent file names can allow quality control to be performed more easily.

Once the job is completed, the media processor 20 transfers the completed job folders back to the media server 16 (again by FTP), storing them in a specified return folder associated with the given media processor 20. A script running on the media server 16 watches the return folder and checks any incoming completed job against the database of outgoing jobs, updates job status information in the database and, after checking the completed job, uploads the job back to the MMS server 14.

Each job is uploaded as a single folder (unbatched), and the MMS server 14 extracts the job details and deletes the job. Jobs may be displayed for approval (quality control) before being dispatched by the MMS server. Alternatively, quality control may be performed under the control of the media server 16, e.g. using approval module 26. The composite image is transmitted by the MMS server 14 to the user device 10 via an MMS message (alternatively, a WAP alert may be transmitted incorporating a link for WAP download of the image).

In the presently described implementation, the process is controlled by a combination of concurrent scripts which run continuously on the media server 16 along with a database management system (DBMS) for managing the media database 18 and storing job information, activity logs and the like. In one example, the media server is an X-Serve G5 running OSX Server, the scripts use the Applescript scripting language and the DBMS is Filemaker Pro. However, other combinations of server hardware, operating software, scripting languages and database software may be used.

A first script is used for the process of downloading new jobs from the MMS server 14, checking their contents and changing image filenames, placing records of the job into the database and then assigning the jobs to media processors and batch folders for retrieval by the media processors. The job batches are also backed up locally before onward transmission. This script will be referred to as the “new jobs” script.

The media processors 20 then log onto the media server 16, download jobs and perform the compositing work, and finally upload the completed work to a specified separate area on their FTP account of the media server.

A second script monitors an area for incoming completed jobs and updates the database, checks against the current job listing and packages the jobs via FTP to the a designated area on the MMS server 14. The jobs are also backed up in batches at this point, before being deleted from the media server. This script is referred to as the “completed jobs” script.

Preferably, there are multiple “completed jobs” scripts running concurrently, each monitoring the incoming job folder for a given media processor 20.

The media server provides user accounts for each media processor, configured to allow FTP access. Each user account contains folders that the monitoring scripts access locally on the media server.

The following is an example directory structure of a user account on the media server 16 (MP stands for media processor)
Users/MP (the MP root account)
Users/MP/OUT (outgoing work for transmission to MP)
Users/MP/IN (completed work coming back from MP)
Users/MP/Rejected (Jobs Rejected by MP)
Users/MP/Backgrounds (backgrounds that the MP will use for compositing)

The IN/OUT folders are preferably created by the scripts, though they may alternatively be created manually before running the scripts. Access permissions for the folders should be set appropriately so that the media processors can access and update the information as required.

The scripts preferably operate continuously on the media server, periodically checking the FTP accounts and watch folders and performing the required actions. No manual interference should normally be necessary, other than periodically moving backed-up folders to an external source or other area, or changing settings inside the database. Further scripts may be provided to automate the backup process.

The scripts are preferably configurable by way of a number of parameters (which may be set using environment variables). The following are examples of script parameters for the “new jobs” script:
The IP address and FTP/http username and password for the MMS server 14 and related FTP/http settings
The delay between checking the MMS server for new jobs
Directory names, for example for the source directories containing batched jobs for transfer to specified media processors, backup folders, folders for storing rejected jobs or jobs containing errors, and local temporary directories for use during job processing
The name of the database used, and names of database tables used for storing jobs details, checking spelling of picture codes (see below) and resolving picture codes to assigned media processors
The number of jobs per batch
The name of a text file used for error reporting

The following are examples of script parameters for the “completed jobs” scripts:
The FTP account details for uploading completed jobs to the MMS server 14
The watch folder for completed jobs transferred from the media processor associated with the given “completed job” script
The names of backup folders and folders for jobs with errors
The name of the database used and the database table used for storing job details
The name of a text file used for error reporting (separate from above)

Starting up the media server involves starting up the database, the “new jobs” script, and any “completed jobs” scripts (one per media processor). The server is preferably configured to perform these actions automatically on powering up.

Generally speaking, during operation of the system, no user interaction with the running scripts or the database is usually needed. However, the database may provide a management interface for managing the process and viewing relevant information. The management interface may be accessible directly at the media server 16 and/or remotely via a web interface.

The management interface allows the assignment of jobs to media processors to be configured by setting the operating mode of the script. The following operating modes are provided:
Normal: Jobs will be allocated to the media processor listed in the database for the relevant picture code. In this mode, scripts operate to watch folders as set out above.
In-House: In this mode, alternative scripts are launched which allocate all jobs to a special “in-house” folder and watch this folder for completed work. Jobs in the “in-house” folder are processed locally at the media server, instead of by an external media processor. This mode can be used for testing or diverting work in-house if required.
According to media processor: Jobs can alternatively be diverted to a specific media processor for a set amount of time (or until the operating mode is changed again), regardless of the allocation specified in the database.

The management interface further provides the following options:
View job details: For viewing/editing a list of jobs with associated job information and status
Configure Picture Codes: For adding, deleting and changing picture codes and configuring spelling correction rules for picture codes (described in more detail below)
Image/Cost Data: For viewing/editing information relating to picture codes, including the full celebrity name, cost information and the media processor to which jobs with that picture code should normally be allocated.

These three options will now be described in more detail.

Job Display

The management interface provides a job display screen for displaying and/or editing information on given jobs. This includes the following information:
Job header information: this contains details of the job itself, including when the job was created, modified, its serial number and a process log key.
Outgoing job information:
   Status information: this shows the process of the job through the system. As the job reaches each stage, such as back-up, deletion from the FTP server etc, status information in the database is updated. If a job fails for any reason, the status information will show where in the process failure occurred. The status information may be in the form of time stamps for various events.
   The picture code supplied by the user (normally in the message field of the MMS message), and the updated picture code after checking/correction (see below). If no updated picture code is shown, this normally means that the picture code specified by the user was not found in the database
   Name of the batch folder to which the job has been allocated. This can help in locating the individual job where there are multiple batch folders. The batch folder name is preferably a 14 digit unique number which gives a date and time stamp to each folder (when it was created), eg. “20041025164229” was created (yyyy-mm-dd hh-mm-ss)=25 Oct. 2004 at 4:42.29pm
   The name or other identifying information of the media processor to which the job has been allocated.
Incoming (completed) job information
   Status information: As the job comes back it is backed up and checked. Status information such as time stamps for procedural steps, is displayed as described above, e.g timestamps for when the job was uploaded back to the MMS server and deleted from the media server
   Processed picture code. The picture code of the image actually used in processing. If this is different from the updated input picture code for any reason, this will cause an error.

Picture Codes

The database stores information on the usable picture codes along with any common alternative spellings of the picture codes. This is achieved by way of a table mapping input picture codes to output picture codes, as in the following example (where ‘<>’ indicates a space):

| Input code | Output code |
|---|---|
| Jayz001 | Jayz001 |
| <>Jayz001 | Jayz001 |
| Jayz<>001 | Jayz001 |

The table contains at least one entry for each picture code simply mapping the picture code to itself. The table may optionally contain further entries mapping alternative spellings of the picture code (in this example containing additional spaces) to the correct form of the picture code.

In operation, the input picture code is received from the user and is compared to the input code field in the database. If found, the input picture code is replaced with the value of the output code field. Thus, in the above example, if a user sends the picture code ‘<>jayz001’ this will be changed to ‘jayz001’ and the script will continue with the corrected code. Any variations of alternative spellings or misspellings can be entered, but all of the outgoing fields should remain correct and the same. An error will occur if the input code specified by the user cannot be found in the database.

The management interface allows the picture code mappings to be viewed and changed.

Image/Cost Data

The image/cost data screen displays a given background image, the name of the image (in the case of a celebrity, this is the full name of the celebrity) and optionally a description of the image, the picture code and associated cost information.

Background images may be assigned to cost categories (for example, a higher-quality image for delivery by email may be assigned a different cost category than a lower-quality image for MMS delivery). In one example, the cost category is encoded as part of the picture code. For example, a picture code such as ‘joli001’ may select an image identified by the text identifier ‘joli’ in cost category 001.

The media processor assigned to the given image is also displayed, and can be changed using the interface. In this way, distribution of work among media processors can be configured, for example to ensure even distribution.

Errors

The scripts include thorough error-checking schemes to ensure that each job has the correct contents before being passed to a media processor, that it is batched into the correct folder and also arrives with the correct picture code and other information. The scripts may also check for duplicate jobs. When the completed job comes back from the media processor, the job is also checked to ensure that the image is named correctly and ready to be sent back to the user.

When an error is detected, the script sends the job to the specified error folder (as specified in a script parameter) and logs the error in an error log, stored as a text file. The “new jobs” and “completed jobs” scripts may each maintain their own error logs.

The error log entries specify the date and the time the error was encountered, the job identifier (or job file name) of the job in question, a descriptive error text and an error code identifying the type of error—for example:

| | | | | Error |
|---|---|---|---|---|
| Date | Time | Job | Error Text | Code |
| 2004-10-29 | 15:40 21 | 5847526.zip | picture code “anat001” | 2700 |
| | | | not recognised | |

This type of error—where a picture code supplied by a user is not found—can help to identify common misspellings of picture codes which can then be added to the database so that they are recognized in future. A single job may generate multiple errors, which are logged in sequence.

Approval

As mentioned above, an approval module 26 may be provided to enable external (typically manual) approval of completed images. The approval module displays completed jobs for review by an operator.

Typically, both the user's original input image and the composite image produced by the media processor are displayed, along with relevant information such as the picture code or and/or name associated with the requested background image. Optionally, the background image may also be displayed, though the operator will typically be able to tell from the name or picture code and the composite image whether the correct image has been used. The operator can also review qualitative aspects of the composite image, such as whether the input image has been scaled and colour-adjusted correctly and whether the image material is deemed suitable and appropriate. The operator can then either approve or reject the job. If approved, the job is then forwarded to the MMS server 14 for onward transmission to the user. If rejected, the job may be resubmitted for compositing and/or flagged for further consideration. The approval module may comprise a web interface (for example implemented as a Macromedia ColdFusion (™) page).

A media processor may also reject a job (for example if the input image is corrupted) by moving it to a designated ‘rejected’ folder on the media server 16. The job can then be reviewed and if appropriate resubmitted to the process.

After an approved job has been uploaded to the MMS server 14, it is deleted from the job folders on media server 16.

As already mentioned, the image processing tasks performed by the media processor may be partly or wholly automated. To achieve adequate quality, it may be preferred that the first step, of identifying and extracting the relevant image portion from the input image (typically the portion representing a person), is performed by a human operator. Colour-adjustment, scaling and positioning with respect to the background image may be automated, but may also benefit from human judgement. In a preferred embodiment, the media processor thus comprises human operators for performing the composition (for example using commercially available image processing applications, such as Adobe Photoshop (™) or the like).

Though the same approach could be used for compositing an input image with a video clip, this may be impractical due to the time taken by a human operator to repeatedly carry out the relevant compositing steps on each frame of the video clip. It may therefore be preferable to automate at least part of the compositing process for video clips.

In one example, this is achieved by way of a predefined Adobe After Effects (™) project. In this example, the input image is first processed (typically manually) to extract the relevant image portion (e.g. the person) and remove the background. The resulting image is then supplied to Adobe After Effects (™) for processing in accordance with the relevant predefined project. Typically, a project is supplied for each source video clip.

The predefined project specifies how the input video is to be integrated into the source video clip. For example, it may simply specify a rectangular area into which the pre-processed input image is to be incorporated. In more complex examples, the project may specify effects such movement of the input image between frames, or three-dimensional projection of the image onto a surface. As an example of the latter, the input image could be “projected” onto a billboard or wall depicted in the source video clip, where that surface is angled with respect to the viewer. Many other effects are of course possible.

Adobe After Effects (™) then renders and outputs the resulting video, for example using Apple Quicktime (™), preferably in two formats (a lower-quality one for traditional mobile telephone networks and a higher-quality one for higher-bandwidth networks such as 3G networks or the Internet). The completed video clip (in the relevant format) is then sent to the recipient's device using a suitable delivery method (for example WAP push in the case of mobile telephone networks). The process is otherwise as described above.

In preferred examples, the processing is split so that all manual work is performed by the media processors 20, with any automated processing performed locally at the media server (or on connected, but local, processing units). Thus, in the video example given above, the media processors perform only the manual processes of extracting the relevant image portion and any necessary pre-processing such as scaling and colour-adjustment, and then forward the pre-processed extracted image portion to the media server. The composition and rendering via After Effects (™) is then performed automatically at the media server. The media server may be connected to multiple rendering workstations for performing the actual rendering, in which case additional scripts may be used for allocating, transmitting and receiving rendering work to and from the workstations. A reference frame from the video clip may however be transmitted to the relevant media processor together with the input image to serve as a reference for operations such as scaling and colour adjustment. The reference frame may include additional information, such as positioning or scale guides to assist in the processing of the input image.

Using the above approach enables all manual image processing work to be outsourced to external service providers. This can be beneficial especially where the external service provider can carry out the manual work in a more cost-effective way.

In some examples, it may be possible to automate the entire process (for example, if an input image is to be inserted in its entirety into a designated space in the background image or video clip), in which case all processing can be performed locally.

As already mentioned, the system can also be extended to allow a user to supply an input video clip for compositing with a source video clip stored in the media database, resulting in a composite video clip. This can be achieved using processes similar to those described above.

Any suitable image or video formats may be used for encoding the output image or video clip. For example, images may use the JPEG format, and videos may use the MPEG4 format. Animations may also be used as input, background and/or output of the compositing process, for example using Macromedia Flash (™) format or similar formats.

It will be understood that the present invention has been described above purely by way of example, and modification of detail can be made within the scope of the invention.

For example, instead of separate scripts interacting with a database, a single integrated application may be provided.

The system may be extended to allow real-time adjustment to the way in which jobs are allocated to media processors, for example using an automated load-balancing approach.

What Is claimed is:

1. A method of providing media data to devices connected to a communications network, comprising:
storing a plurality of media objects, each media object comprising image data;
receiving a request from a device connected to the network, the request comprising input image data and specifying one of the plurality of stored media objects;
compositing at least a portion of the input image data with image data of the specified media object to produce a composite media object; and
transmitting the composite media object to the device.

2. A method according to claim 1, wherein the compositing step comprises selecting a portion of the input image data, extracting the selected portion from the input image data, and compositing the extracted portion with image data of the specified media object.

3. A method according to claim 2, wherein the input image data comprises an image portion representative of a person, the selecting step selecting that image portion.

4. A method according to claim 3, wherein the specified media object comprises image data representative of a further person, the compositing step comprising compositing the input image portion representative of the person with the image data representative of the further person, preferably so as to generate composite image data representative of the person being in the company of the further person.

5. A method according to claim 4, wherein the plurality of stored media objects comprises a plurality of media objects depicting well-known personalities or celebrities.

6. A method according to claim 1, wherein the specified media object comprises a region designated for receiving input image data, and wherein compositing the portion of the input image data with image data of the specified media object comprises inserting the portion into the designated region.

7. A method according to claim 1, comprising storing processing information relating to the specified media object, the compositing step comprising compositing the input image data portion with image data of the specified media object in accordance with the processing information.

8. A method according to claim 7, wherein the processing information specifies a region in an image or a region or regions in one or more frames of the specified media object for insertion of the input image data.

9. A method according to claim 7, wherein the processing information specifies one or more processing operations to be performed on the input image portion prior to insertion into the image data of the specified media object, the one or more processing operations preferably comprising one or more of: a colour modification operation, a resizing operation, a cropping operation, and projection onto a three-dimensional surface.

10. A method according to claim 7, wherein the processing information comprises a template, script or project file for use with an image processing application, the method comprising invoking the image processing application using the template, script or project file.

11. A method according to claim 10, comprising storing a plurality of templates, scripts or project files, each associated with a respective one of the plurality of media objects, and selecting the template, script or project file in dependence on the media object specified in the request.

12. A method according to claim 1, comprising reviewing the composite image to determine whether the quality of the composite image meets an acceptable quality standard, and outputting the composite media object to the device only in the event of a positive determination.

13. A method according to claim 1, wherein the plurality of stored media objects comprises images, animations and/or video clips.

14. A method according to claim 1, wherein the input image data is in the form of an image, animation or a video clip.

15. A method according to claim 1, wherein the composite media object is an image, animation or a video clip.

16. A method according to claim 1, wherein the request is in the form of an MMS message or an email message.

17. A method according to claim 1, wherein the request comprises a text identifier specifying the media object.

18. A method according to claim 17, wherein each media object is associated with a respective text identifier, the method comprising storing a table mapping alternative spellings of given text identifiers to the given text identifiers, and replacing the text identifier received in the request with the text identifier specified for the received text identifier in the table.

19. A method according to claim 1, comprising transmitting the composite media object to the device using MMS, WAP push or email.

20. A method according to claim 1, comprising receiving the request at a media server; in response to receiving the request, selecting one of a plurality of media processors connected to the media server; and performing at least part of the compositing step at the selected media processor.

21. A method of providing media data to devices connected to a communications network, comprising:
storing a plurality of video clips, each video clip comprising a plurality of frames of image data;
receiving a request from a device connected to the network, the request comprising input image data and specifying one of the plurality of stored video clips;
compositing at least a portion of the input image data with one or more frames of the specified video clip to produce a composite video clip; and
transmitting the composite video clip to the device.

22. A media processing system for use with a communications network, comprising:
a database adapted to store a plurality of media objects, each media object comprising image data;
a media server connectable to the communications network, adapted to receive a request from a device connected to the communications network, the request comprising input image data and specifying one of the plurality of stored media objects;
means for performing a compositing process to composite at least a portion of the input image data with image data of the specified media object to produce a composite media object; and
means for transmitting the composite media object to the device.

23. A media processing system according to claim 22, further comprising a plurality of media processors, each media processor being adapted to perform at least a part of the compositing process, the media server being adapted to select one of the plurality of media processors, and assign the compositing request to the selected media processor for processing.

24. A media processing system according to claim 23, wherein the compositing process includes a manual operation, each media processor being operable to perform a part of the compositing process including the manual operation.

25. A media processing system according to claim 24, wherein each media processor is operable to perform all manual operations forming part of the compositing process.

26. A media processing system according to claim 23, each media processor being operable to perform the entire compositing process.

27. A media processing system according to claim 23, the media server being adapted to output job information to the selected media processor, the job information comprising the input image data; the selected media processor being adapted to receive the job information and process the input image data to perform the compositing process or part of the compositing process.

28. A media processing system according to claim 27, wherein the job information comprises the specified media object or an identifier identifying the specified media object, the selected media processor being adapted to generate the composite media object using the input image data and the specified media object.

29. A media processing system according to claim 23, wherein the media server is adapted to output the job information by storing the job information in a job information store, the plurality of media processors being adapted to access the job information store, retrieve job information from the job information store, and process the retrieved job information to perform the compositing process or part of the compositing process.

30. A media processing system according to claim 29, wherein the media processors are adapted to output processing results to the media server by storing the processing results in the job information store, the processing results preferably comprising a composite media object.

31. A media processing system according to claim 29, wherein the job information store comprises a designated storage area for each media processor, the media server being adapted to assign a given request to a media processor by storing job information for the given request in the designated storage area for the media processor.

32. A media processing system according to claim 31, comprising means for executing a plurality of concurrent processes at the media server, each process being associated with a respective one of the plurality of media processors and being adapted to monitor the designated storage area for that media processor and, in response to processing results being stored in the designated storage area by that media processor, the processing results preferably comprising the composite media object, further processing the processing results, preferably by transmitting the composite media object to the device.

33. A media processing system according to claim 32, further comprising means for executing a further process concurrently with the plurality of concurrent processes, the further process being adapted to receive the request, select the one of the plurality of media processors and assign the request to the selected media processor.

34. A media processing system according to claim 22, wherein the communications network comprises a mobile telecommunications network, the request being transmitted by the device in the form of an MMS message.

35. A media processing system according to claim 34, further comprising an MMS processing system adapted to receive the MMS message, to extract the input image and the information specifying the media object from the message, and to transmit the input information and the specifying information to the media server.

36. A media processing system according to claim 22, wherein the communications network comprises the Internet, the system further comprising a web site providing an interface for submitting the request.

37. A media processing system according to claim 36, wherein the interface is adapted to display a plurality of the media objects stored in the database, and to receive a selection specifying one of the plurality of displayed media objects.

38. A method according to claim 36, the interface further comprising means for uploading the input image data.

39. A computer program or computer program product comprising software code adapted, when executed on a data processing apparatus, to perform a method of providing media data to devices connected to a communications network, comprising:
storing a plurality of media objects, each media object comprising image data;
receiving a request from a device connected to the network, the request comprising input image data and specifying one of the plurality of stored media objects;
compositing at least a portion of the input image data with image data of the specified media object to produce a composite media object; and
transmitting the composite media object to the device.
